(19) United States
(12) Patent Application Publication
(10) Pub. No.: US 2025/0055573 A1
(43) Pub. Date: Feb. 13, 2025

(54) GAIN ADJUSTMENT METHOD, OPTICAL RECEIVING APPARATUS AND COMPUTER PROGRAM

(71) Applicant: NIPPON TELEGRAPH AND TELEPHONE CORPORATION, Tokyo (JP)

(72) Inventors: Kyo MINOGUCHI, Musashino-shi (JP); Etsushi YAMAZAKI, Musashino-shi (JP); Yoshiaki KISAKA, Musashino-shi (JP); Kengo HORIKOSHI, Musashino-shi (JP); Seiji OKAMOTO, Musashino-shi (JP); Masanori NAKAMURA, Musashino-shi (JP)

(73) Assignee: NIPPON TELEGRAPH AND TELEPHONE CORPORATION, Tokyo (JP)

(21) Appl. No.: 18/717,521

(22) PCT Filed: Dec. 24, 2021
(86) PCT No.: PCT/JP2021/048206

§ 371 Date: Jun. 7, 2024

(51) Int. Cl. H04B 10/61; H04B 10/294

(52) U.S. Cl. CPC H04B 10/61; H04B 10/2942

(57) ABSTRACT

A gain adjustment method in an optical transmission system that performs communication by a digital coherent system including an optical transmission device and an optical reception device includes converting an optical signal transmitted from the optical transmission device into an electrical signal, converting the electrical signal from an analog signal to a digital signal, performing first signal processing on the digital signal, performing adaptive equalization processing on the digital signal subjected to the first signal processing using a digital filter, correcting an amplitude of an output signal of the digital filter based on information of the amplitude and a phase of the output signal of the digital filter and the amplitude of a known transmission signal, and performing second signal processing on the output signal of the digital filter whose amplitude has been corrected.

### TECHNICAL FIELD

The present invention relates to a gain adjustment method, an optical reception device, and a computer program.

### BACKGROUND ART

In coherent optical communication, polarization/phase diversity transmission and reception are realized, and digital signal processing utilizing phase information obtained on a reception side is realized (see, for example, Non Patent Literature 1). Crosstalk and linear distortion between polarization multiplexed signals are equalized by adaptive coefficient control of a digital filter represented by a finite impulse response (FIR) filter, and crosstalk and a delay difference between in-phase and quadrature of a quadrature amplitude modulation (QAM) signal can be similarly equalized by adaptive coefficient control of the FIR filter. At this time, coefficient control for minimizing a mean square error from the reference signal can be used.

### CITATION LIST

### Non Patent Literature

Non Patent Literature 1: Seb J. Savory, “Digital filters for coherent optical receivers”, Vol. 16, Issue 2, pp. 804-817 (2008).

### SUMMARY OF INVENTION

### Technical Problem

However, when coefficient control that minimizes the mean square error is performed in the digital filter in an environment where noise exists, the filter coefficient converges such that the amplitude of the transmission signal component in the digital filter output deviates from the expected value. Therefore, there is a problem that the amplitude of the transmission signal component of the output of the digital filter deviates from the expected value, which affects the processing of the signal processing unit subsequent to the digital filter, and in this case, the accuracy of the signal processing is deteriorated.

In view of the above circumstances, an object of the present invention is to provide a technique capable of improving accuracy of signal processing by a signal processing unit at a stage subsequent to a digital filter.

### Solution to Problem

An aspect of the present invention is a gain adjustment method in an optical transmission system that performs communication by a digital coherent system including an optical transmission device and an optical reception device, the method including converting an optical signal transmitted from the optical transmission device into an electrical signal, converting the electrical signal from an analog signal to a digital signal, performing first signal processing on the digital signal, performing adaptive equalization processing on the digital signal subjected to the first signal processing using a digital filter, correcting an amplitude of an output signal of the digital filter based on information of the amplitude and a phase of the output signal of the digital filter and the amplitude of a known transmission signal, and performing second signal processing on the output signal of the digital filter whose amplitude has been corrected.

An aspect of the present invention is an optical reception device in an optical transmission system that performs communication by a digital coherent system including an optical transmission device and an optical reception device, the device including a coherent optical reception unit that converts an optical signal transmitted from the optical transmission device into an electrical signal, an analog-to-digital conversion unit that converts the electrical signal from an analog signal to a digital signal, a first signal processing unit that performs first signal processing on the digital signal, an adaptive equalization unit that performs performing adaptive equalization processing on the digital signal subjected to the first signal processing using a digital filter, an amplitude correction unit that corrects an amplitude of an output signal of the digital filter based on information of the amplitude and a phase of the output signal of the digital filter and the amplitude of a known transmission signal, and a second signal processing unit that performs second signal processing on the output signal of the digital filter whose amplitude has been corrected.

An aspect of the present invention is a computer program for causing a computer to function as an optical reception device in an optical transmission system that performs communication by a digital coherent system including an optical transmission device and an optical reception device, the computer program including converting an optical signal transmitted from the optical transmission device into an electrical signal, converting the electrical signal from an analog signal to a digital signal, performing first signal processing on the digital signal, performing adaptive equalization processing on the digital signal subjected to the first signal processing using a digital filter, and correcting an amplitude of an output signal of the digital filter based on information of the amplitude and a phase of the output signal of the digital filter and the amplitude of a known transmission signal.

### Advantageous Effects of Invention

According to the present invention, it is possible to improve the accuracy of the signal processing by the signal processing unit at the stage subsequent to the digital filter.

### BRIEF DESCRIPTION OF DRAWINGS

FIG. 1 is a diagram illustrating a system configuration of an optical transmission system in a first embodiment.

FIG. 2 is a diagram illustrating a configuration example of a digital signal processing unit in the first embodiment.

FIG. 3 is a diagram for illustrating processing performed by an amplitude correction unit in the first embodiment.

FIG. 4 is a diagram for illustrating processing performed by the amplitude correction unit in the first embodiment.

FIG. 5 is a flowchart illustrating a flow of processing of an optical reception device in the first embodiment.

FIG. 6 is a diagram for illustrating processing performed by an amplitude correction unit in a second embodiment.

FIG. 7 is a diagram for illustrating processing performed by the amplitude correction unit in the second embodiment.

### DESCRIPTION OF EMBODIMENTS

Hereinafter, embodiments of the present invention will be described with reference to drawings.

### First Embodiment

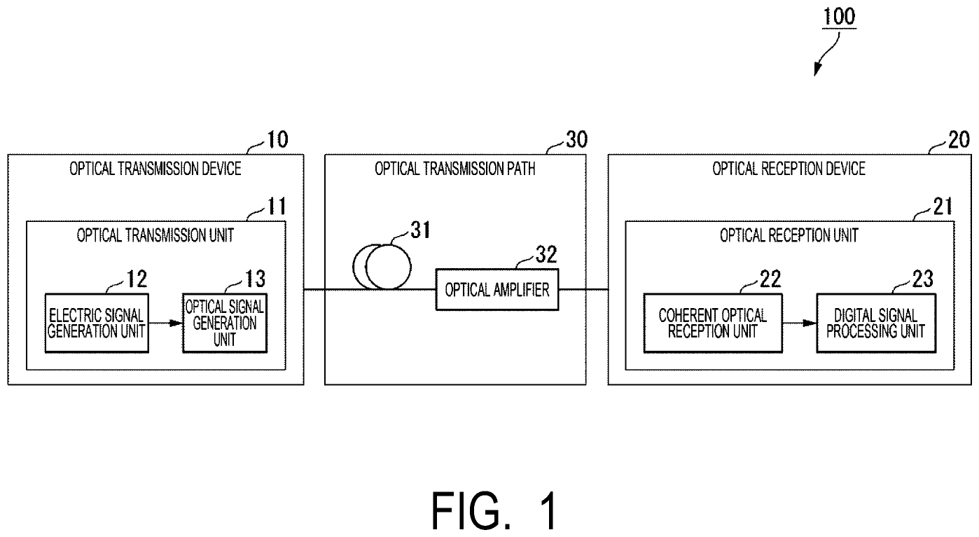

FIG. 1 is a diagram illustrating a system configuration of an optical transmission system 100 in a first embodiment. The optical transmission system 100 includes an optical transmission device 10 and an optical reception device 20. The optical transmission device 10 and the optical reception device 20 are connected via an optical transmission path 30. The optical transmission path 30 transmits an optical signal transmitted by the optical transmission device 10 to the optical reception device 20. The optical transmission path 30 includes an optical fiber 31 that connects the optical transmission device 10 and the optical reception device 20 and an optical amplifier 32 that amplifies an optical signal. Note that, in the optical transmission path 30, a device such as an optical switch or a reproduction repeater may be inserted in the middle of the path.

The optical transmission device 10 includes an optical transmission unit 11 that transmits an optical signal. The optical transmission unit 11 includes an electrical signal generation unit 12 and an optical signal generation unit 13. The electrical signal generation unit 12 encodes transmission data that is an information source, and converts the encoded transmission data into a waveform of an electrical signal to generate and output an electrical signal of the transmission data.

The optical signal generation unit 13 converts the electrical signal generated by the electrical signal generation unit 12 into an optical signal, and transmits the optical signal to the optical reception device 20 via the optical transmission path 30. The inside of the optical signal generation unit 13 includes a digital-to-analog converter, a driver amplifier, a modulator, a laser, and the like. The optical signal generation unit 13 generates an optical signal using, for example, a quadrature phase shift keying (QPSK) modulation scheme.

The optical reception device 20 includes an optical reception unit 21 that receives an optical signal. The optical reception unit 21 includes a coherent optical reception unit 22 and a digital signal processing unit 23. Inside the coherent optical reception unit 22, a 90 degree optical hybrid circuit, a local oscillation light source, a photodetector, and optical fibers that couple them are provided. Note that the coherent optical reception unit 22 may be provided with an analog-to-digital converter, or an analog-to-digital converter may be provided between the coherent optical reception unit 22 and the digital signal processing unit 23.

The coherent optical reception unit 22 separates a baseband optical signal into two optical signals having polarization planes orthogonal to each other. These optical signals and a locally emitted light of a local oscillation light source are input to a 90 degree optical hybrid circuit, and a total of four output lights of a set of output lights in which both lights interfere with each other in the same phase and the opposite phase and a set of output lights in which both lights interfere with each other orthogonally) (90° and inverse-orthogonally) (−90° are obtained. The output light is converted from an optical signal to an analog electrical signal by a photodiode. The analog-to-digital converter converts the analog signal into a digital signal and outputs the digital signal to the digital signal processing unit 23.

When an optical signal propagates through the optical transmission path 30, a signal waveform is distorted by a non-linear optical effect in which a phase of the signal rotates in proportion to optical power of the signal. The digital signal processing unit 23 takes in the digital signal output from the analog-to-digital converter as a reception signal, and performs various kinds of compensation on the taken reception signal.

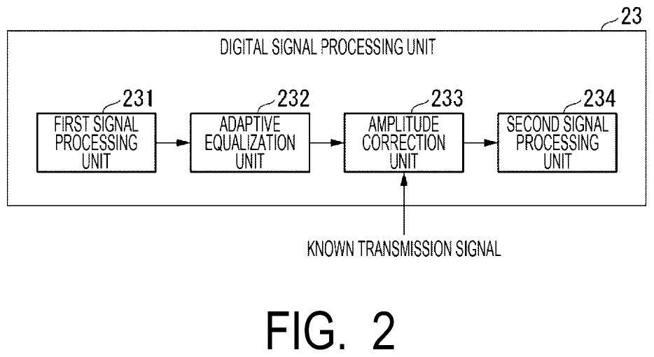

FIG. 2 is a diagram illustrating a configuration example of the digital signal processing unit 23 in the first embodiment. The digital signal processing unit 23 includes a first signal processing unit 231, an adaptive equalization unit 232, an amplitude correction unit 233, and a second signal processing unit 234.

The first signal processing unit 231 performs signal processing on the input digital signal. For example, the first signal processing unit 231 compensates for wavelength dispersion generated in the optical transmission path 30 in the input digital signal. Note that the signal processing performed by the first signal processing unit 231 is not limited thereto, and other signal processing may be performed. For example, the first signal processing unit 231 may perform any signal processing as long as the signal processing is conventionally performed before the adaptive equalization processing is performed by the adaptive equalization unit 24.

The adaptive equalization unit 232 compensates for distortion generated in the waveform of the optical signal in the optical transmission path 30. That is, the adaptive equalization unit 232 corrects a code error generated in an optical signal due to interference between codes (inter-symbol interference) in the optical transmission path 30. The adaptive equalization unit 232 executes an adaptive equalization process using a digital filter such as an FIR filter (finite impulse response filter) according to the set tap coefficient.

The amplitude correction unit 233 corrects the amplitude of the reception signal based on the four digital signals (digital filter outputs) on which the adaptive equalization processing has been executed and the known transmission signal. As described above, the amplitude correction unit 233 uses the known transmission signal as a part of the processing of amplitude correction of the reception signal.

The second signal processing unit 234 performs signal processing on the four digital signals subjected to the adaptive equalization processing and corrected by the amplitude correction unit 233. For example, the second signal processing unit 234 performs processing of compensating for a frequency offset, processing of compensating for a phase offset, and demodulation and decoding on the input digital signal. Note that the signal processing performed by the second signal processing unit 234 is not limited thereto, and other signal processing may be performed. For example, the second signal processing unit 234 may perform any signal processing as long as the signal processing is conventionally performed after the adaptive equalization processing is performed by the adaptive equalization unit 24.

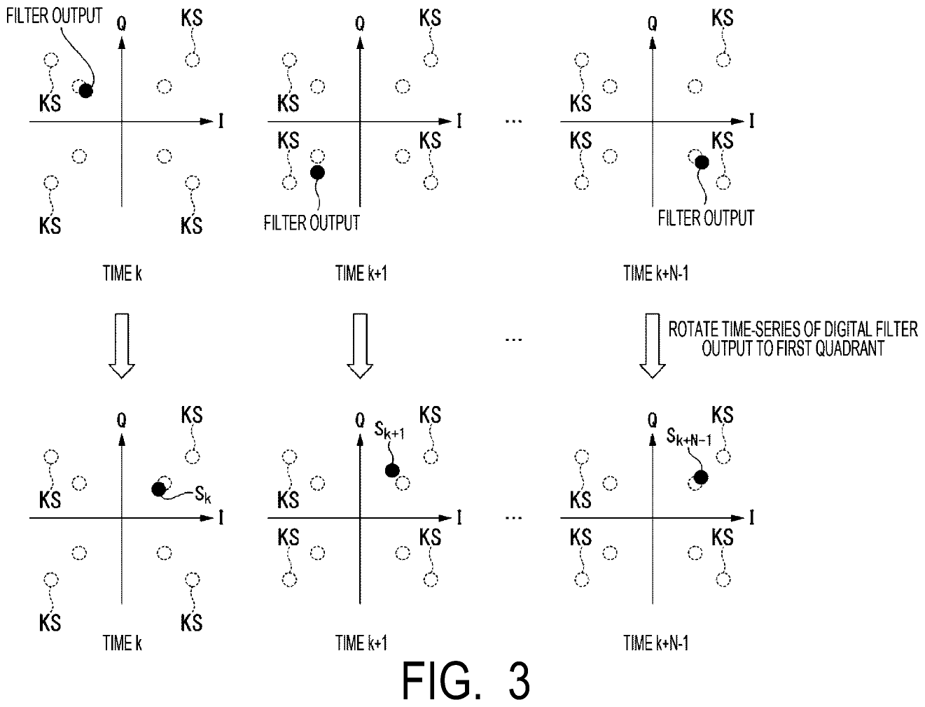

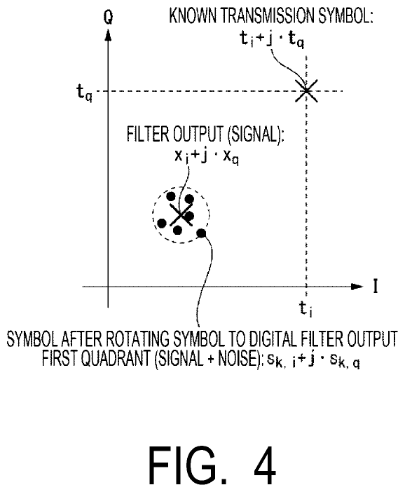

FIGS. 3 and 4 are diagrams for illustrating processing performed by the amplitude correction unit 233 in the first embodiment. FIG. 3 illustrates time-series data output from the adaptive equalization unit 232. For example, FIG. 3 illustrates time-series data of the output from the adaptive equalization unit 232 obtained at each of a time k to a time k+N−1. The time-series data in the upper part of FIG. 3 illustrates a symbol KS of a known transmission signal and a symbol of a filter output. The amplitude correction unit 233 rotates the symbol of the filter output at each time from the current position to the first quadrant.

As a result, the time-series data in the upper part of FIG. 3 is converted into the time-series data illustrated in the lower part of FIG. 3. Black circles (Sₖ, Sₖ₊₁, . . . , S_{k+N-1}) in the time-series data illustrated in the lower part of FIG. 3 represent the amplitude after the symbol of the filter output is rotated to a first quadrant. Note that Sₖ, Sₖ₊₁, . . . , S_{k+N-1} belong to complex numbers. Here, the reason why the time-series of the symbols of the filter output is rotated on the complex plane and collected in one quadrant (for example, the first quadrant) is that, since the digital filter output is randomly disposed in the first to fourth quadrants, if the addition average of the symbols of the filter output is taken without being rotated, it statistically converges to 0, and the signal component (xᵢ+j·x_{q}) cannot be calculated.

Furthermore, it is also possible to implement a method equivalent to that of the first embodiment by taking an addition average for each quadrant. However, in this case, memories for holding the averaging results for four quadrants are individually required. Therefore, the memory can be reduced in the method of collecting in one quadrant.

The amplitude correction unit 233 calculates the amplitudes xᵢ, x_{q} of the known transmission signal components based on Equation (1) below using the value of the amplitude at each time after the symbol of the filter output is rotated to the first quadrant.

$$[ Math . 1 ]$$

$$\begin{matrix}{x}_{i} = 1 / N \cdot {\sum }_{k = 1}^{N} {s}_{k , i} \\ {x}_{q} = 1 / N \cdot {\sum }_{k = 1}^{N} {s}_{k , q}\end{matrix} \qquad Equation ( 1 )$$

Note that N in Equation (1) represents the number of symbols used for gain estimation. The amplitudes xᵢ, x_{q} of the known transmission signal components obtained based on Equation (1) are illustrated in FIG. 4. Furthermore, the amplitude correction unit 233 calculates gains gᵢ, g_{q} in the in-phase component reception signal and the quadrature-phase component based on Equation (2) below using the amplitudes xᵢ, x_{q} of the known transmission signal components obtained based on Equation (1). The gains gᵢ, g_{q} correspond to the amplitude correction amount of the in-phase component reception signal and the amplitude correction amount of the quadrature-phase component reception signal.

$$\begin{matrix}[ Math . 2 ] & \end{matrix}$$

$$\begin{matrix}{g}_{i} = {h}_{i} \cdot \frac{{t}_{i}}{{x}_{i}} \\ {g}_{q} = {h}_{q} \cdot \frac{{t}_{q}}{{x}_{q}}\end{matrix} \qquad Equation ( 2 )$$

Note that hᵢ, h_{q} in Equation (2) represent gain estimation result correction coefficients (In-Phase/Quadrature), and tᵢ, t_{q} represent known transmission signal QPSK amplitudes (In-Phase/Quadrature) used for coefficient control of the adaptive equalization unit 232.

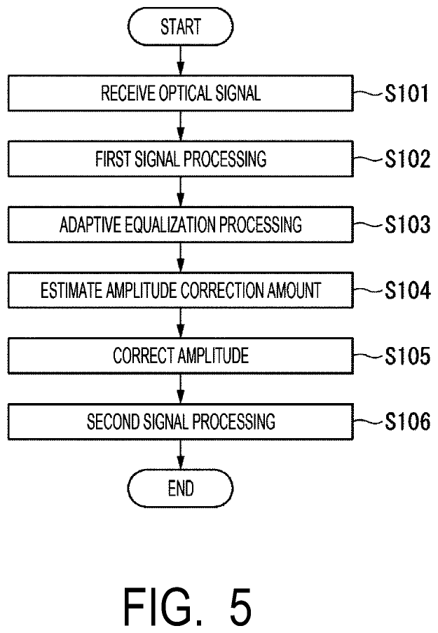

FIG. 5 is a flowchart illustrating a flow of processing of the optical reception device 20 in the first embodiment.

The coherent optical reception unit 22 receives the optical signal transmitted from the optical transmission device 10 (Step S101). The optical signal received by the coherent optical reception unit 22 is converted into an electrical signal, then converted from an analog signal to a digital signal by an analog-to-digital converter, and input to the digital signal processing unit 23.

The first signal processing unit 231 performs first signal processing on the input digital signal (Step S102). The first signal processing unit 231 outputs the digital signal subjected to the first signal processing to the adaptive equalization unit 232. The adaptive equalization unit 232 performs adaptive equalization processing on the digital signal that has been subjected to the first signal processing and has been output from the first signal processing unit 231 (Step S103).

The digital signal subjected to the adaptive equalization processing by the adaptive equalization unit 232 is input to the amplitude correction unit 233. The amplitude correction unit 233 estimates the amplitude correction amount of the reception signal using the digital signal on which the adaptive equalization processing has been performed (Step S104). Specifically, first, the amplitude correction unit 233 rotates the symbol of the filter output at each time to the first quadrant in the time-series data of the digital signal (filter output) subjected to the adaptive equalization processing. Next, the amplitude correction unit 233 calculates the amplitudes xᵢ, x_{q} of the known transmission signal components by Equation (1) above using the value of the amplitude at each time after the symbol of the filter output is rotated to the first quadrant. Then, using the values of the amplitudes xᵢ, x_{q} of the known transmission signal components, the amplitude correction unit 233 calculates gains gᵢ, g_{q} in the in-phase component reception signal and the quadrature-phase component as an in-phase component (gain gᵢ) of the amplitude correction amount and a quadrature-phase component (g_{q}) of the amplitude correction amount based on Equation (2) above.

The amplitude correction unit 233 uses the calculated amplitude correction amount to correct the amplitude of the in-phase component digital signal and the amplitude of the quadrature-phase component digital signal on which the adaptive equalization processing has been performed (Step $105). Specifically, the amplitude correction unit 233 corrects the amplitude of the in-phase component digital signal and the amplitude of the quadrature-phase component digital signal by multiplying the in-phase component of the amplitude correction amount by the in-phase component digital signal and multiplying the quadrature-phase component of the amplitude correction amount by the quadrature-phase component digital signal. The amplitude correction unit 233 outputs the corrected in-phase component digital signal and the corrected quadrature-phase component digital signal to the second signal processing unit 234. The second signal processing unit 234 performs second signal processing on the corrected in-phase component digital signal and the corrected quadrature-phase component digital signal output from the amplitude correction unit 233 (Step S106). As a result, the second signal processing unit 234 restores the data transmitted from the optical transmission device 10.

According to the optical transmission system 100 configured as described above, it is possible to improve the accuracy of signal processing by the signal processing unit at the stage subsequent to the digital filter. Specifically, in the optical transmission system 100, the amplitude of the reception signal is corrected based on the output signal from the digital filter and the known transmission signal, and the signal is output to the subsequent signal processing unit (second signal processing unit 234). As a result, as compared with the conventional signal processing in which the output from the digital filter is directly passed to the signal processing unit in the subsequent stage, the signal processing in the subsequent stage is performed after an amplitude of the reception signal is corrected, so that the symbol position is more accurately determined in the decoding processing. Therefore, highly accurate signal processing can be performed. As a result, the accuracy of the signal processing by the signal processing unit at the stage subsequent to the digital filter can be improved.

A modification example of the first embodiment will be described.

In the above-described embodiment, the configuration has been described in which the amplitude correction unit 233 calculates the amplitude correction amount of the in-phase component reception signal and the amplitude correction amount of the quadrature-phase component reception signal based on the result of averaging the digital filter outputs for the predetermined period. The amplitude correction unit 233 may calculate the amplitude correction amount of the in-phase component reception signal and the amplitude correction amount of the quadrature-phase component reception signal based on a result of averaging the absolute values of the digital filter outputs for a predetermined period.

In the above-described embodiment, the configuration in which the amplitude correction unit 233 rotates the symbol of the filter output at each time to the first quadrant has been described. The amplitude correction unit 233 may rotate the symbol of the filter output at each time to a quadrant other than the first quadrant. For example, the amplitude correction unit 233 may rotate the symbol of the filter output at each time to any quadrant of the second quadrant to the fourth quadrant. As described above, the amplitude correction unit 233 can achieve the above effect by rotating the symbol of the filter output at each time to any arbitrary quadrant from the first quadrant to the fourth quadrant.

### Second Embodiment

In a second embodiment, a configuration in which an amplitude correction amount is estimated based on a time-series of an error between an output of a digital filter and a symbol of a known transmission signal and the amplitude of the reception signal is corrected will be described. The configuration of the second embodiment is similar to that of the first embodiment. The processing in the amplitude correction unit 233 is different from that of the first embodiment. Hereinafter, differences from the first embodiment will be described.

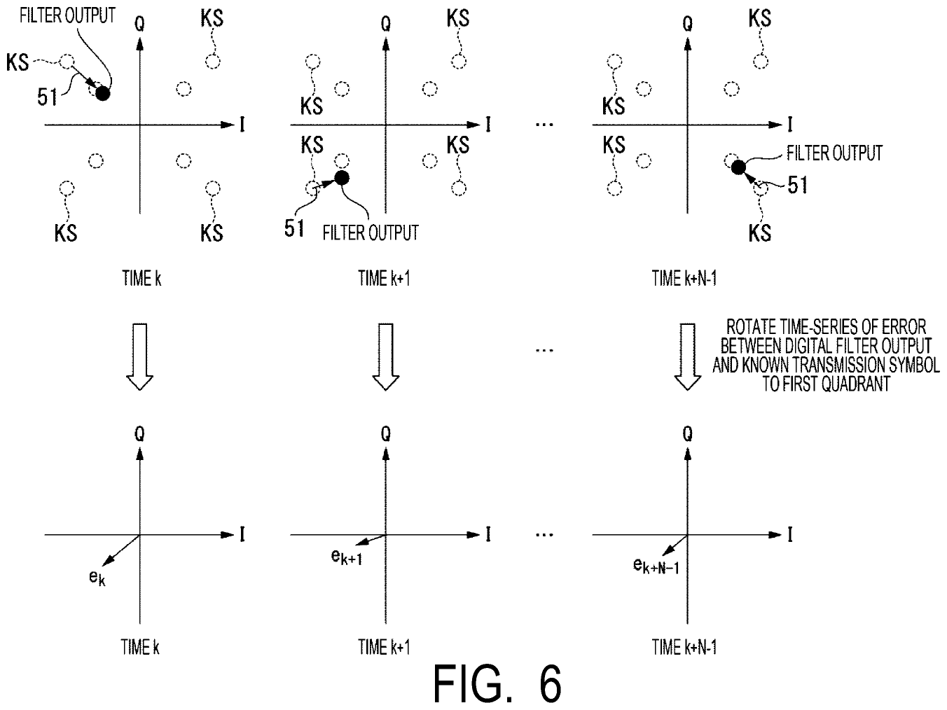

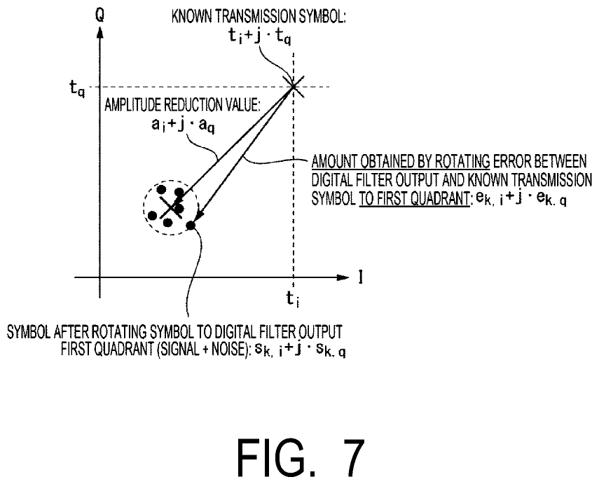

FIGS. 6 and 7 are diagrams for illustrating processing performed by the amplitude correction unit 233 in the second embodiment. FIG. 6 illustrates time-series data output from the adaptive equalization unit 232. For example, FIG. 6 illustrates time-series data of the output from the adaptive equalization unit 232 obtained at each of the time k to the time k+N−1. The time-series data in the upper part of FIG. 6 illustrates the symbol KS of a known transmission signal and the symbol of the filter output. Furthermore, an arrow 51 illustrated in the time-series data in the upper part of FIG. 6 represents an error between the symbol KS of the known transmission signal and the symbol of the filter output. The amplitude correction unit 233 rotates the arrow 51 indicating the error at each time from the current position to the first quadrant.

As a result, the time-series data in the upper part of FIG. 6 is converted into the time-series data illustrated in the lower part of FIG. 6. Arrows (eₖ, eₖ₊₁, . . . , e_{k+N-1}) in the time-series data illustrated in the lower part of FIG. 6 represents an amount obtained by rotating the error between the digital filter output and the known transmission signal to the first quadrant. Note that eₖ, eₖ₊₁, . . . , e_{k+N-1} belong to complex numbers. Here, the reason why the time series of errors is rotated on the complex plane and collected in one quadrant (for example, the first quadrant) is the same as that in the first embodiment. Furthermore, the advantage in taking the averaging for each quadrant is the same reason as in the first embodiment.

The amplitude correction unit 233 calculates amounts (In-Phase/Quadrature) aᵢ, a_{q} representing the difference between the known transmission signal component after the digital filter output is rotated to the first quadrant and the known transmission signal based on Equation (3) below using the value of the error at each time after the error between the digital filter output and the known transmission signal is rotated to the first quadrant.

$$[ Math . 3 ]$$

$$\begin{matrix}{a}_{i} = 1 / N \cdot {\sum }_{k = 1}^{N} {e}_{k , i} \\ {a}_{q} = 1 / N \cdot {\sum }_{k = 1}^{N} {e}_{k , q}\end{matrix} \qquad Equation ( 3 )$$

The amounts aᵢ, a_{q} representing the difference obtained based on Equation (3) are illustrated in FIG. 7.

Further, the amplitude correction unit 233 calculates gains gᵢ, g_{q} in the in-phase component reception signal and the quadrature-phase component as an in-phase component (gain gᵢ) of the amplitude correction amount and a quadrature-phase component (g_{q}) of the amplitude correction amount based on Equation (4) below using the amounts aᵢ, a_{q} representing the differences obtained based on Equation (3). The gains gᵢ, g_{q} correspond to the amplitude correction amount of the in-phase component reception signal and the amplitude correction amount of the quadrature-phase component reception signal.

$$\begin{matrix}[ Math . 4 ] & \end{matrix}$$

$$\begin{matrix}{g}_{i} = {h}_{i} \cdot \frac{{t}_{i}}{{t}_{i} - \vert {a}_{i} \vert} \\ {g}_{q} = {h}_{q} \cdot \frac{{t}_{q}}{{t}_{q} - \vert {a}_{q} \vert}\end{matrix} \qquad Equation ( 4 )$$

The amplitude correction unit 233 corrects the amplitude of the in-phase component digital signal and the amplitude of the quadrature-phase component digital signal by multiplying the in-phase component of the calculated amplitude correction amount by the in-phase component digital signal and multiplying the quadrature-phase component of the amplitude correction amount by the quadrature-phase component digital signal.

According to the optical transmission system 100 in the second embodiment configured as described above, similar to the first embodiment, it is possible to improve the accuracy of signal processing by the signal processing unit at the stage subsequent to the digital filter. Furthermore, as compared with the first embodiment, the value range can be narrowed by converting into an error between the digital filter output and the known transmission signal. Therefore, the bit width of the arithmetic circuit can be effectively used as compared with the first embodiment.

A modification of the second embodiment will be described.

In the above-described embodiment, the configuration has been described in which the amplitude correction unit 233 calculates the amplitude correction amount of the in-phase component reception signal and the amplitude correction amount of the quadrature-phase component reception signal based on the result of averaging the errors between the digital filter outputs for the predetermined period and the known transmission signal. The amplitude correction unit 233 may calculate the amplitude correction amount of the in-phase component reception signal and the amplitude correction amount of the quadrature-phase component reception signal based on a result of averaging the absolute values of the error between the digital filter outputs for a predetermined period and the known transmission signal.

In the above-described embodiment, the configuration has been described in which the amplitude correction unit 233 rotates the value of the error between the digital filter output and the known transmission signal at each time to the first quadrant. The amplitude correction unit 233 may rotate the position of the error between the digital filter output and the known transmission signal at each time to a quadrant other than the first quadrant. For example, the amplitude correction unit 233 may rotate the error at each time to any quadrant of the second quadrant to the fourth quadrant. As described above, the amplitude correction unit 233 can achieve the above effect by rotating the error at each time to any arbitrary quadrant from the first quadrant to the fourth quadrant.

Some functions of the optical reception device 20 in the above-described embodiments may be implemented by a computer. In that case, a program for implementing the functions may be recorded in a computer-readable recording medium, and the program recorded in the recording medium may be read and executed by a computer system to implement the functions. Note that the “computer system” herein includes an operating system (OS) and hardware such as peripheral devices. In addition, the “computer-readable recording medium” refers to a portable medium such as a flexible disk, a magneto-optical disk, a read only memory (ROM), or a CD-ROM, or a storage device such as a hard disk included in a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be for implementing the functions described above in a combination with a program already recorded in a computer system, or may be implemented with a programmable logic device such as a field programmable gate array (FPGA).

Although the embodiment of the present invention has been described in detail with reference to the drawings, specific configurations are not limited to the embodiment, and include designs and the like without departing from the scope of the invention.

### INDUSTRIAL APPLICABILITY

The present invention can be applied to an optical transmission system technology that performs equalization processing using a digital filter.

### REFERENCE SIGNS LIST

10 Optical transmission device
11 Optical transmission unit
12 Electrical signal generation unit
13 Optical signal generation unit
20 Optical reception device
21 Optical reception unit
22 Coherent optical reception unit
23 Digital signal processing unit
30 Optical transmission path
31 Optical fiber
32 Optical amplifier
231 First signal processing unit
232 Adaptive equalization unit
233 Amplitude correction unit
234 Second signal processing unit

1. A gain adjustment method in an optical transmission system that performs communication by a digital coherent system including an optical transmission device and an optical reception device, the gain adjustment method comprising:
converting an optical signal transmitted from the optical transmission device into an electrical signal;
converting the electrical signal from an analog signal to a digital signal;
performing first signal processing on the digital signal;
performing adaptive equalization processing on the digital signal subjected to the first signal processing using a digital filter;
correcting an amplitude of an output signal of the digital filter based on information of the amplitude and a phase of the output signal of the digital filter and the amplitude of a known transmission signal; and
performing second signal processing on the output signal of the digital filter whose amplitude has been corrected.

2. The gain adjustment method according to claim 1, further comprising:
estimating an amplitude correction amount for correcting the amplitude of the output signal of the digital filter based on a result of averaging absolute values of the output of the output signal of the digital filter for a predetermined period or the output of the output signal of the digital filter for a predetermined period.

3. The gain adjustment method according to claim 2, further comprising:
estimating the amplitude correction amount based on a result obtained by rotating an output of an output signal of the digital filter for a predetermined period to any one quadrant of a first quadrant to a fourth quadrant in a complex number plane and then averaging the result.

4. The gain adjustment method according to claim 1, further comprising:
estimating an amplitude correction amount for correcting the amplitude of the output signal of the digital filter based on a result of averaging absolute values of an error between the output of the output signal of the digital filter for a predetermined period and a known transmission signal or an error between the output of the output signal of the digital filter for a predetermined period and a known transmission signal.

5. The gain adjustment method according to claim 4, further comprising:
estimating the amplitude correction amount based on a result obtained by rotating an error between an output of an output signal of the digital filter for a predetermined period and a known transmission signal to any one quadrant of a first quadrant to a fourth quadrant in a complex number plane and then averaging the result.

6. An optical reception device in an optical transmission system that performs communication by a digital coherent system including an optical transmission device and an optical reception device, the optical reception device comprising:
a coherent optical receiver configured to convert an optical signal transmitted from the optical transmission device into an electrical signal;
an analog-to-digital converter configured to convert the electrical signal from an analog signal to a digital signal;
a first signal processor configured to perform first signal processing on the digital signal;
an adaptive equalizer configured to perform adaptive equalization processing on the digital signal subjected to the first signal processing using a digital filter;
an amplitude corrector configured to correct an amplitude of an output signal of the digital filter based on information of the amplitude and a phase of the output signal of the digital filter and the amplitude of a known transmission signal; and
a second signal processor configured to perform second signal processing on the output signal of the digital filter whose amplitude has been corrected.

7. A non-transitory computer readable storage medium that stores a computer program to be executed by the computer for causing a computer to function as an optical reception device in an optical transmission system that performs communication by a digital coherent system including an optical transmission device and an optical reception device;
converting an optical signal transmitted from the optical transmission device into an electrical signal; converting the electrical signal from an analog signal to a digital signal; performing first signal processing on the digital signal; performing adaptive equalization processing on the digital signal subjected to the first signal processing using a digital filter; and correcting an amplitude of an output signal of the digital filter based on information of the amplitude and a phase of the output signal of the digital filter and the amplitude of a known transmission signal.
